(19) United States
(12) Patent Application Publication
(10) Pub. No.: US 2020/0404109 A1
(43) Pub. Date: Dec. 24, 2020

(54) INFORMATION PROCESSING APPARATUS, NON-TRANSITORY COMPUTER READABLE MEDIUM, AND INFORMATION PROCESSING SYSTEM

(71) Applicant: FUJI XEROX CO., LTD., Tokyo (JP)

(72) Inventor: Hideaki TAKAYAMA, Kanagawa (JP)

(73) Assignee: FUJI XEROX CO., LTD., Tokyo (JP)

(21) Appl. No.: 16/695,454

(22) Filed: Nov. 26, 2019

(30) Foreign Application Priority Data
Jun. 18, 2019 (JP) 2019-112657

(51) Int. Cl. H04N 1/00; H04N 1/32; H04W 4/33; H04W 4/021

(52) U.S. Cl. CPC H04N 1/00344; H04N 1/32614; H04W 4/021; H04W 4/33; H04N 1/32662

(57) ABSTRACT

An information processing apparatus includes an obtaining unit that obtains positional information regarding a worker who maintains an operation apparatus that performs a process requested by a user and a search unit that searches for, among plural operation apparatuses, an operation apparatus provided at a position a predetermined distance or more away from a position indicated by the positional information obtained by the obtaining unit as an operation apparatus to perform the process requested by the user.

### CROSS-REFERENCE TO RELATED APPLICATIONS

This application is based on and claims priority under 35 USC 119 from Japanese Patent Application No. 2019-112657 filed Jun. 18, 2019.

### BACKGROUND

### (i) Technical Field

The present disclosure relates to an information processing apparatus, a non-transitory computer readable medium, and an information processing system.

### (ii) Related Art

Japanese Unexamined Patent Application Publication No. 11-161447 discloses a printer selection apparatus including job reception means for receiving a print job transmitted through a network, printer information request means for requesting information regarding printing frequencies in addition to information regarding performance, functions, and states of printers connected to the printer selection apparatus, printer selection means for selecting, on the basis of the information, a printer to perform printing, and job transmission means for transmitting the print job to the selected printer.

Japanese Unexamined Patent Application Publication No. 2005-38082 discloses a maintenance support system that supports maintenance of a device. The maintenance support system includes technique level information storage means storing technique level information indicating a technique level of each of maintenance workers, positional information storage means storing positional information indicating a location of each of the maintenance workers, worker selection means for selecting one of the maintenance workers, required time calculation means for calculating required maintenance time taken to complete the maintenance of the device, estimated arrival time calculation means for calculating an estimated arrival time, at which each of the maintenance workers will arrive at a location of the device, completion time calculation means for calculating a maintenance completion time, at which the maintenance of the device will be completed, on the basis of the required maintenance time calculated by the required time calculation means and the estimated arrival time calculated by the estimated arrival time calculation means, and completion time notification means for notifying of the maintenance completion time calculated by the completion time calculation means. The required time calculation means calculates the required maintenance time on the basis of technique level information corresponding to the maintenance worker selected by the worker selection means in the technique level information stored in the technique level information storage means. The estimated arrival time calculation means calculates the estimated arrival time on the basis of positional information corresponding to the maintenance worker selected by the worker selection means in the positional information stored in the positional information storage means.

### SUMMARY

There is an information processing apparatus that assigns a process requested by a user to a found one of a plurality of apparatuses and causes the apparatus to perform the process.

If maintenance is scheduled to be performed on an apparatus to be caused to perform a process requested by the user, the information processing apparatus might not assign the process to the apparatus, because use of the apparatus will be inhibited during a period for which the maintenance is scheduled to be performed.

The maintenance of the apparatus, however, is not necessarily performed continuously from a scheduled start time to a scheduled end time of the maintenance. For example, the maintenance of the apparatus might be started after the scheduled start time of the maintenance. Even in the period in which the maintenance of the apparatus is scheduled to be performed, the apparatus to be maintained may actually be used in some parts of the period.

Aspects of non-limiting embodiments of the present disclosure relate to an information processing apparatus, a non-transitory computer readable medium, and an information processing system capable of improving the accuracy of searching for an apparatus that can perform a process requested by a user, compared to when an apparatus to perform the process is searched for among a plurality of apparatuses such that the apparatus will not perform the process in a scheduled maintenance period of the apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an obtaining unit that obtains positional information regarding a worker who maintains an operation apparatus that performs a process requested by a user and a search unit that searches for, among a plurality of operation apparatuses, an operation apparatus provided at a position a predetermined distance or more away from a position indicated by the positional information obtained by the obtaining unit as an operation apparatus to perform the process requested by the user.

### BRIEF DESCRIPTION OF THE DRAWINGS

An exemplary embodiment of the present disclosure will be described in detail based on the following figures, wherein:

FIG. 1 is a diagram illustrating an example of a plan of an office;

FIG. 2 is a diagram illustrating an example of the system configuration of an information processing system;

FIG. 3 is a block diagram illustrating an example of the functional configuration of a user terminal;

FIG. 4 is a block diagram illustrating an example of the functional configuration of a printer server;

FIG. 5 is a block diagram illustrating an example of the functional configuration of a printer;

FIG. 6 is a diagram illustrating an example of the configuration of an electrical system of the printer server and the user terminal;

FIG. 7 is a diagram illustrating an example of the configuration of an electrical system of the printer;

FIG. 8 is a flowchart illustrating a process for searching for a printer according to a first exemplary embodiment;

FIG. 9 is a diagram illustrating an example of a plan of the office for describing distances along passages;

FIG. 10 is a flowchart illustrating an example of a process for searching for a printer according to a first modification of the first exemplary embodiment;

FIG. 11 is a flowchart illustrating an example of a process for searching for a printer according to a second modification of the first exemplary embodiment;

FIG. 12 is a diagram illustrating an example of a track of a worker pointing away from the printer; and

FIG. 13 is a diagram illustrating an example of a track of a worker passing by the printer.

### DETAILED DESCRIPTION

An exemplary embodiment will be described hereinafter with reference to the drawings. Components and processes having the same functions will be given the same reference numerals throughout the drawings, and redundant description thereof is omitted.

### First Exemplary Embodiment

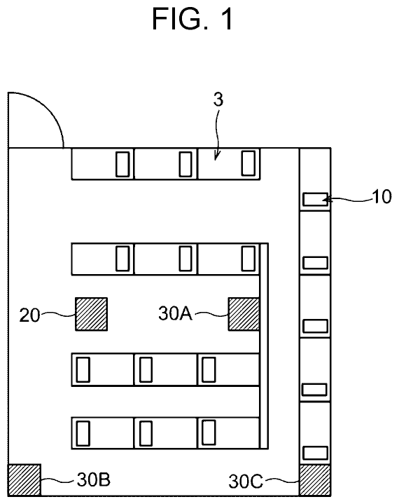

FIG. 1 is a diagram illustrating an example of a plan of an office in which users work. In the office, printers 30A, 30B, and 30C (hereinafter generically referred to as “printers 30” when the printers need not be distinguished from one another) that form images on a recording medium such as sheets of paper and a printer server 20 that receives image data from a user terminal 10 operated by one of the users, transmits the received image data to a found one of the printers 30, and causes the printer 30 to which the image data has been transmitted to form an image based on the image data are provided.

Seats 3 assigned to different users are also provided in the office, and a user terminal 10 is provided for each of the seats 3.

In order to prevent occurrence of unexpected failures in the printers 30 as much as possible, workers 15 in charge of maintenance of the printers 30 maintain the printers 30. Because a printer 30 becomes temporarily unavailable while a worker 15 is maintaining the printer 30, the printer server 20 selects a printer 30 to which image data is to be transmitted from printers 30 other than the printer 30 that is currently being maintained.

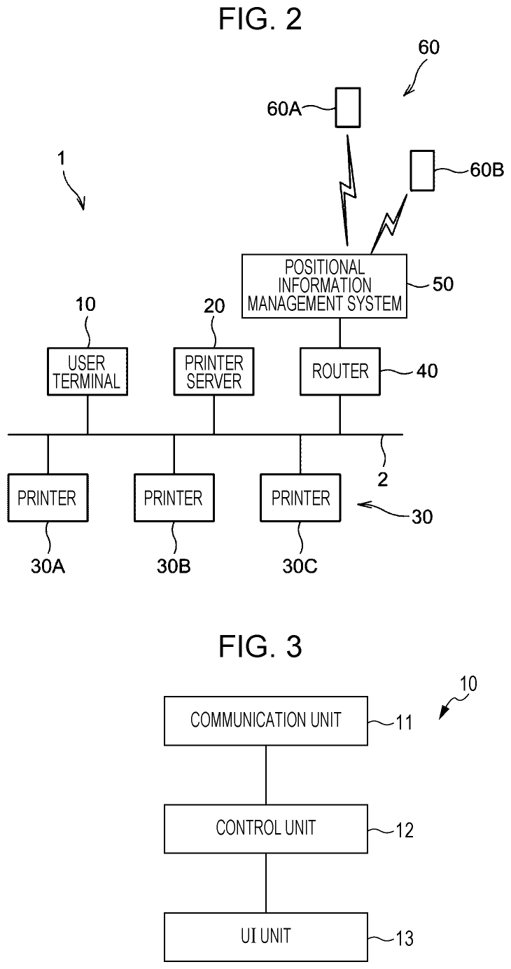

FIG. 2 is a diagram illustrating an example of the system configuration of an information processing system 1 that selects, in consideration of maintenance work performed on a printer 30, a printer 30 to form, on the recording medium, an image based on image data received from a user terminal 10.

The information processing system 1 includes a user terminal 10, the printer server 20, and the printers 30. The user terminal 10, the printer server 20, and the printers 30 are connected to one another by a communication link 2. Although only one user terminal 10 is illustrated in the example of the information processing system 1 illustrated in FIG. 2, a plurality of user terminals 10 may be connected to the communication link 2, instead. The number of printers 30 connected to the communication link 2 is not limited to three, and any number of printers 30 may be connected to the communication link 2. Although the information processing system 1 includes one printer server 20 in the following description for convenience of description, a plurality of printer servers 20 may be connected to the communication link 2, instead.

A router 40 is connected to the communication link 2, and a positional information management system 50 is connected through the router 40.

The router 40 is a network device to which different systems (the information processing system 1 and the positional information management system 50 herein) are connected and that transfers data for the systems.

The positional information management system 50 is connected to mobile terminals 60 carried by the workers 15 through a wireless link. The positional information management system 50 obtains positional information regarding the mobile terminals 60 and transmits the positional information to, for example, the printer server 20. Although the positional information management system 50 transmits the positional information regarding the mobile terminals 60 to the printer server 20 in the present exemplary embodiment, the positional information management system 50 may transmit the positional information regarding the mobile terminals 60 to each of the printers 30, instead.

The mobile terminals 60 carried by the workers 15 each have a function of obtaining positional information regarding the mobile terminal 60 itself using a positioning system such as a global positioning system (GPS). Any type of mobile terminals 60 may be used insofar as the mobile terminals 60 have the function of obtaining positional information. For example, portable information devices such as smartphones, tablet computers, wearable devices to be worn by the workers 15, or GPS terminals are used.

Although mobile terminals 60A and 60B are connected to the positional information management system 50 in the example illustrated in FIG. 2, a term “mobile terminals 60” will be generically used when the mobile terminals 60 need not be distinguished from one another. The number of mobile terminals 60 connected to the positional information management system 50 is not limited, and at least one mobile terminal 60 is connected.

The positional information regarding the mobile terminals 60 carried by the workers 15 also serves as positional information regarding the workers 15. The positional information, therefore, might be referred to as “positional information regarding the workers 15” in the following description.

A communication protocol used in the communication link 2 is not limited. The communication link 2 may be a wired link or a wireless link, or may be a link that employs both a wired link and a wireless link. Furthermore, the communication link 2 may be a dedicated link or a public link shared by a large number of users, such as the Internet.

Next, an example of the functional configuration of the devices included in the information processing system 1 will be described.

FIG. 3 is a block diagram illustrating an example of the functional configuration of the user terminal 10. As illustrated in FIG. 3, the user terminal 10 includes a communication unit 11, a control unit 12, and a user interface (UI) unit 13.

The communication unit 11 is connected to the communication link 2 and communicates data with the other devices connected to the communication link 2. For example, the communication unit 11 transmits, to the printer server 20, image data received from the control unit 12 and receives, from the printer server 20, a result of formation of an image based on the transmitted image data.

The control unit 12 generates, in accordance with a user's instruction received through the UI unit 13, image data in which the content of an image specified by the user is described in a printer control language interpretable by the printers 30 and transmits the image data to the communication unit 11.

The UI unit 13 receives instructions from the user and notifies the user of various pieces of information such as responses to the user's instructions. The UI unit 13 receives specification of an image to be output from one of the printers 30, for example, and displays a result of formation of the specified image.

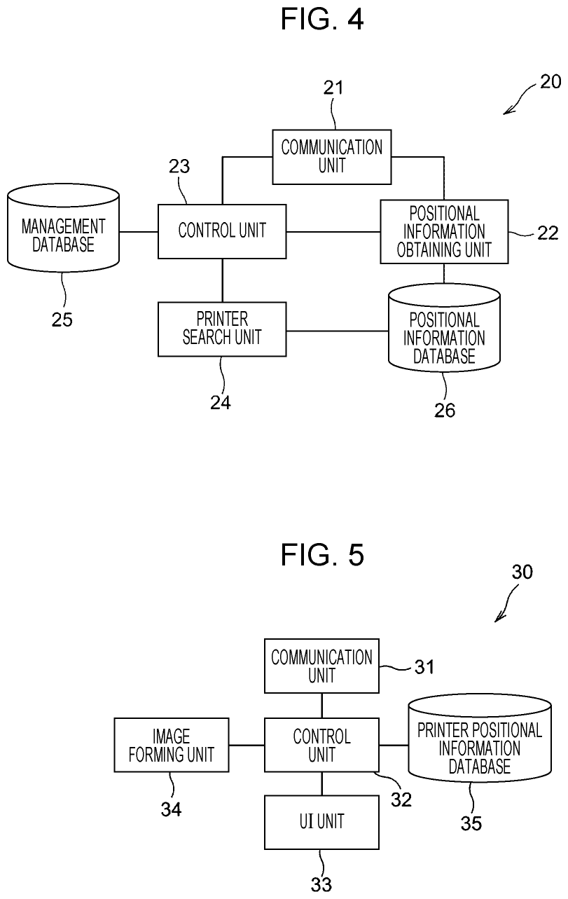

FIG. 4 is a block diagram illustrating an example of the functional configuration of the printer server 20. As illustrated in FIG. 4, the printer server 20 includes functional units, namely a communication unit 21, a positional information obtaining unit 22, a control unit 23, and a printer search unit 24, a management database 25, and a positional information database 26.

The communication unit 21 is connected to the communication link 2 and communicates data with other devices connected to the communication link 2. For example, the communication unit 21 receives image data from the user terminal 10 and a result of formation of an image based on the image data from one of the printers 30. The communication unit 21 also receives the positional information regarding the printers 30 from the printers 30 and the positional information regarding the workers 15 from the positional information management system 50.

Furthermore, the communication unit 21 transmits the image data received from the user terminal 10 to one of the printers 30 specified by the control unit 23 and a result of formation of an image received from the printer 30 to the user terminal 10 that has transmitted the image data.

The positional information obtaining unit 22 obtains the positional information regarding the printers 30 from the printers 30 through the communication unit 21 and the positional information regarding the workers 15 from the positional information management system 50 and stores the positional information in the positional information database 26. The positional information obtaining unit 22 is an example of an obtaining unit according to the present exemplary embodiment.

The control unit 23 controls a timing at which the positional information obtaining unit 22 obtains the positional information regarding the printers 30 and the positional information regarding the workers 15 and stores image data received by the communication unit 21 in the management database 25. The control unit 23 also causes the printer search unit 24 to search for a printer 30 to form an image using the received image data and the communication unit 21 to transmit the received image data to the printer 30 found by the printer search unit 24.

The printer search unit 24 searches for one of the printers 30 (hereinafter referred to as “registered printers 30”) included in the information processing system 1 as a printer to form an image based on image data transmitted by the user. The printer search unit 24 is an example of a search unit according to the present exemplary embodiment.

The management database 25 is a management mechanism that manages identifiers, such as Internet protocol (IP) addresses, for uniquely identifying user terminals 10 that have transmitted image data and the image data while associating the identifiers and the image data with each other. The management database 25 manages image data while associating information necessary to manage the image data, such as time points at which the image data has been received, with the image data, as well as the identifiers of the user terminals 10.

The positional information database 26 is a management mechanism that associates the registered printers 30 with the positional information regarding the registered printers 30 and the workers 15, that is, the mobile terminals 60, with obtained positional information regarding the workers 15. The positional information regarding the workers 15 is managed in time series for a certain period of time, which starts at times at which the positional information is obtained. The positional information regarding the printers 30 to be managed is latest positional information regarding the printers 30.

The management database 25 and the positional information database 26 need not necessarily be constructed in the printer server 20, and may be constructed in a file server, which is not illustrated, or the like connected to the communication link 2, instead. In this case, the positional information obtaining unit 22 and the control unit 23 may communicate with the positional information database 26 and the management database 25, respectively, through the communication unit 21.

The printer server 20, which obtains the positional information regarding the workers 15 and searches for one of the registered printers 30 as a printer to perform a process requested by the user, is an example of an information processing apparatus according to the present exemplary embodiment.

FIG. 5 is a block diagram illustrating an example of the functional configuration of a printer 30. The printer 30 includes functional units, namely a communication unit 31, a control unit 32, a UI unit 33, and an image forming unit 34, and a printer positional information database 35.

The communication unit 31 is connected to the communication link 2 and communicates data with the other devices connected to the communication link 2. For example, the communication unit 31 receives image data transmitted from the user terminal 10 through the printer server 20 and also receives, from the printer server 20, a positional information request instruction for requesting positional information regarding the printer 30.

The control unit 32 controls processes performed by the functional units of the printer 30. When the communication unit 31 has received image data, for example, the control unit 32 causes the image forming unit 34 to form an image based on the received image data on the recording medium. The control unit 32 then receives a result of the formation of the image based on the image data from the image forming unit 34. The control unit 32 causes the communication unit 31 to transmit the received result of the formation of the image to the printer server 20 that has transmitted the image data and the UI unit 33 to display information regarding the formation of the image specified by the user using the UI unit 33.

If the communication unit 31 receives a positional information request instruction, the control unit 32 causes the communication unit 31 to obtain positional information regarding the corresponding printer 30 managed by the printer positional information database 35 and transmit the obtained positional information regarding the corresponding printer 30 to the printer server 20 that has transmitted the positional information request instruction.

The image forming unit 34 forms an image based on image data specified by the control unit 32 on the recording medium and transmits a result of the formation of the image, which indicates whether the image has been normally formed, to the control unit 32. The image forming unit 34 also notifies the control unit 32 of an event that has occurred during the formation of the image (e.g., absence of the recording medium on which the image is to be formed) and statistical information regarding the formation of the image (e.g., the accumulated number of times of formation of an image). A result of formation of an image, an event that has occurred during formation of an image, and statistical information regarding formation of an image are examples of information regarding formation of an image.

The UI unit 33 receives instructions from the user and notifies the user of various pieces of information including responses to the user's instructions and information regarding formation of an image.

For example, the UI unit 33 receives the positional information regarding the corresponding printer 30 from the user, and the control unit 32 stores the received positional information regarding the printers 30 in the printer positional information database 35. As a result, the positional information regarding the corresponding printer 30 is stored in the printer positional information database 35. The user may obtain the positional information regarding the printer 30 using the function of obtaining positional information achieved by a GPS terminal, a smartphone, or the like and set the obtained positional information regarding the printer 30 to the printer 30 using the UI unit 33.

A method for setting positional information regarding a printer 30 is not limited to this. For example, positional information regarding a printer 30 may be set through the communication link 2. More specifically, a setting application for setting positional information regarding a printer 30 may be installed on at least one of the user terminals 10 or one of the printer servers 20, and positional information regarding a printer 30 specified using the setting application may be set. The control unit 32 of the printer 30 receives the positional information regarding the printer 30 through the communication unit 31 and stores the received positional information in the printer positional information database 35. When a GPS unit or the like having the function of obtaining positional information is mounted on the printer 30, the control unit 32 may obtain positional information from the GPS unit and store the positional information regarding the printer 30 in the printer positional information database 35.

The communication unit 31 and the UI unit 33 that receive a process requested by the user are examples of a reception unit according to the present exemplary embodiment, and the communication unit 31 that transmits the positional information regarding the printer 30 is also an example of a transmission unit according to the present exemplary embodiment.

The printer 30 that performs a process requested by the user, such as formation of an image, is an example of an operation apparatus according to the present exemplary embodiment.

Next, an example of the configuration of an electrical system of the printer server 20 will be described.

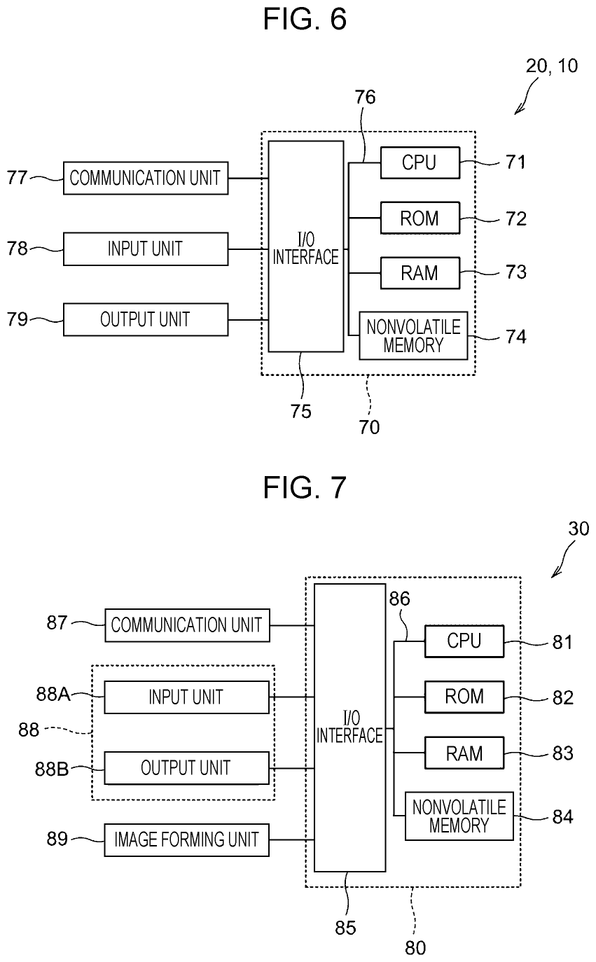

FIG. 6 is a diagram illustrating an example of the configuration of the electrical system of the printer server 20. The printer server 20 is achieved, for example, by a computer 70.

The computer 70 includes a central processing unit (CPU) 71 that serves as the functional units of the printer server 20, a read-only memory (ROM) 72 storing an information processing program for causing the computer 70 to function as the functional units illustrated in FIG. 4, a random-access memory (RAM) 73 used as a temporary working area for the CPU 71, a nonvolatile memory 74, and an input/output (I/O) interface 75. The CPU 71, the ROM 72, the RAM 73, the nonvolatile memory 74, and the I/O interface 75 are connected to one another through the bus 76.

The nonvolatile memory 74 is an example of a storage device that keeps stored information even after power supplied thereto is stopped. The nonvolatile memory 74 is a semiconductor memory, for example, but may be a hard disk, instead.

The management database 25 and the positional information database 26 of the printer server 20 may be constructed in the RAM 73 or the nonvolatile memory 74.

A communication unit 77, an input unit 78, and an output unit 79, for example, are connected to the I/O interface 75.

The communication unit 77 is connected to the communication link 2 and has a communication protocol for communicating data with the other devices connected to the communication link 2.

The input unit 78 receives an instruction from the user and transmits the instruction to the CPU 71. The input unit 78 may be, for example, buttons, a touch panel, a keyboard, a mouse, or the like. When the user's instruction is received through sound, a microphone may be used as the input unit 78.

The output unit 79 is an example of a device that outputs information processed by the CPU 71 to the user and may be a liquid crystal display, an organic electroluminescent (EL) display, or the like. When the user is notified of information through sound, a speaker may be used as the output unit 79.

The units connected to the I/O interface 75 are an example, and units other than those illustrated in FIG. 6 may be connected as necessary, instead.

The example of the configuration of the electrical system of the printer server 20 illustrated in FIG. 6 also applies to the user terminal 10. In this case, however, the ROM 72 stores a user terminal program for causing the computer 70 to function as the functional units illustrated in FIG. 3, and the CPU 71 serves as the functional units relating to the user terminal 10.

FIG. 7, on the other hand, is a diagram illustrating the configuration of an electrical system of the printer 30. The printer 30 is achieved, for example, by a computer 80.

The computer 80 includes a CPU 81 that serves as the functional units of the printer 30, a ROM 82 storing an image forming program for causing the computer 80 to function as the functional units illustrated in FIG. 5, a RAM 83 used as a temporary working area for the CPU 81, a nonvolatile memory 84, and an I/O interface 85. The CPU 81, the ROM 82, the RAM 83, the nonvolatile memory 84, and the I/O interface 85 are connected to one another through the bus 86.

A communication unit 87, an operation unit 88, and an image forming unit 89, for example, are connected to the I/O interface 85.

As with the communication unit 77 of the printer server 20, the communication unit 87 is connected to the communication link 2 and has a communication protocol for communicating data with other devices connected to the communication link 2.

The operation unit 88 offers an interface with the printer 30 to the user. More specifically, the operation unit 88 includes an input unit 88A and an output unit 88B.

The input unit 88A is a device that receives an instruction from the user and transmits the instruction to the CPU 81. The input unit 88A may be, for example, buttons, a touch panel, a pointing device, or the like. When the user's instruction is received through sound, a microphone may be used as the input unit 88A.

The output unit 88B is an example of a device that outputs information processed by the CPU 81 to the user and may be a liquid crystal display, an organic EL display, or the like. When the user is notified of information through sound, a speaker may be used as the output unit 88B.

A touch panel, which is an example of the input unit 88A, is mounted on the output unit 88B. If a button on a screen displayed in the output unit 88B is pressed, for example, information regarding a position at which the user has pressed the button is input to the touch panel, and the CPU 81 performs a process corresponding to the button displayed at the position.

Next, an operation performed by the information processing system 1 to form, in consideration of maintenance work for the printer 30, an image based on image data received from the user terminal 10 will be described in detail.

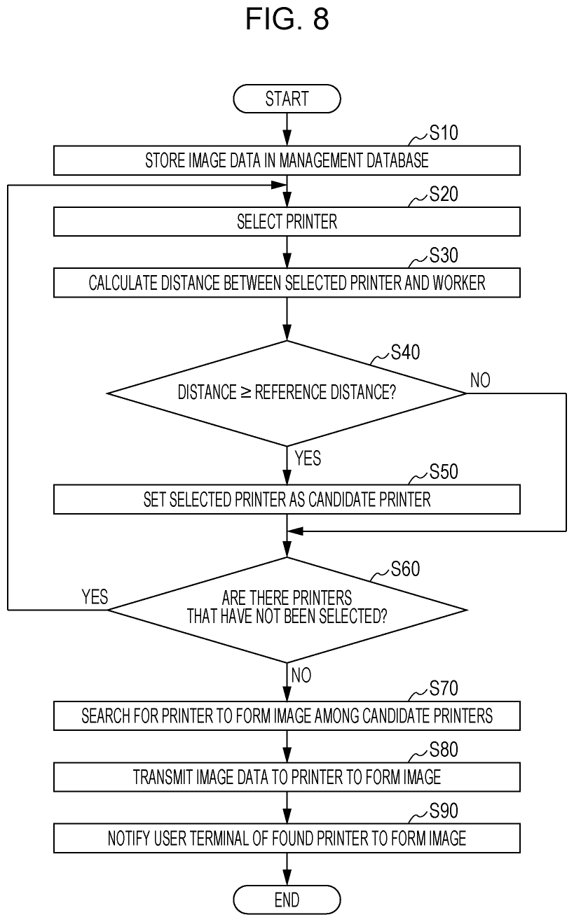

FIG. 8 is a flowchart illustrating an example of a process for searching for a printer performed by the CPU 71 of the printer server 20 when image data has been received from the user terminal 10. The information processing program that specifies the process for searching for a printer is stored, for example, in the ROM 72 of the printer server 20 in advance. The CPU 71 of the printer server 20 reads the information processing program stored in the ROM 72 and performs the process for searching for a printer.

It is assumed that the printer server 20 obtains positional information regarding the printers 30 included in the information processing system 1 at a time when the image data has been received and stores the positional information in the nonvolatile memory 74. The printer server 20 also obtains the positional information regarding the workers 15 at predetermined time intervals, for example, and stores the obtained positional information regarding the workers 15 in the nonvolatile memory 74 in time series. It is assumed here that a single worker 15 performs maintenance work for the printers 30 for convenience of description.

In step S10, the CPU 71 stores the received image data in the RAM 73. The CPU 71 also stores a file name of the image data in the RAM 73 while associating the file name with an identifier of a user terminal 10 that has transmitted the image data.

In step S20, the CPU 71 selects one of the printers 30 included in the information processing system 1 that has not been selected yet.

In step S30, the CPU 71 obtains positional information regarding the printer 30 selected in step S20 (hereinafter referred to as a “selected printer 30”) and positional information regarding the worker 15 from the nonvolatile memory 74 and calculates a distance between the selected printer 30 and the worker 15. The positional information regarding the worker 15 used to calculate the distance between the selected printer 30 and the worker 15 is latest positional information regarding the worker 15, that is, positional information indicating a latest location of the worker 15.

When the plurality of workers 15 maintain the printers 30, charge information indicating a worker in charge of each printer 30 is stored in one of the storage devices included in the information processing system 1, such as the nonvolatile memory 74. The CPU 71 may refer to the charge information and calculate the distance between the selected printer 30 and the worker 15 who maintains the selected printer 30.

A direct distance may be calculated as the distance between the printer 30 and the worker 15. When there is a wall or a seat on a straight line connecting the printer 30 and the worker 15 to each other, however, the worker 15 walks to the printer 30 through a passage. In this case, therefore, a distance along the passage may be calculated. When map data corresponding to the plan of the office in which the printer 30 to be maintained illustrated in FIG. 1 is provided is stored in the nonvolatile memory 74 in advance, the CPU 71 refers to the map data regarding the plan of the office and calculates the distance between the selected printer 30 and the worker 15 along the passage.

It is assumed in the present exemplary embodiment that the CPU 71 calculates the distance between the selected printer 30 and the worker 15 along the passage. In the following description, the distance between the selected printer 30 and the worker 15 along the passage will be simply referred to as a “distance between the selected printer 30 and the worker 15”.

When there are a plurality of workers 15, each of the workers 15 carries a mobile terminal 60. Positional information regarding each worker 15, therefore, is obtained. In this case, the CPU 71 calculates a distance between the selected printer 30 and each worker 15.

The CPU 71 stores the calculated distance between the selected printer 30 and the worker 15 in the RAM 73.

In step S40, the CPU 71 determines whether the distance between the selected printer 30 and the worker 15 calculated in step S30 is equal to or larger than a reference distance.

The “reference distance” is a threshold used to determine whether the worker 15 is maintaining the selected printer 30. When the worker 15 maintains the selected printer 30, the worker 15 needs to approach the selected printer 30. The reference distance, therefore, is set at a minimum value of distances at which it is unlikely that the worker 15 is maintaining the selected printer 30. That is, if the worker 15 is located at a position the reference distance or more away from the selected printer 30, the CPU 71 determines that the worker 15 is not maintaining the selected printer 30.

If the distance between the selected printer 30 and the worker 15 calculated in step S30 is equal to or larger than the reference distance, therefore, the process proceeds to step S50.

When the plurality of workers 15 maintain the printers 30 but correspondences between the workers 15 and the printers 30 are not determined in advance, the process may proceed to step S50 if all distances between the selected printer 30 and the workers 15 are equal to or larger than the reference distance.

The reference distance is set at a distance obtained by analyzing the motion of the workers 15 during actual maintenance work or conducting an analysis of a computer simulation obtained by modeling the motion of the workers 15 during actual maintenance work. The reference distance is then stored, for example, in the nonvolatile memory 74.

If the distance between the selected printer 30 and the worker 15 is equal to or larger than the reference distance, it is expected that the worker 15 is not maintaining the selected printer 30. That is, the printer 30 can form an image.

In step S50, therefore, the CPU 71 sets the selected printer 30 as a candidate for a printer 30 that can form an image, that is, a “candidate printer”, and the process proceeds to step S60.

If the distance between the selected printer 30 and the worker 15 is smaller than the reference distance, it is expected that the worker 15 is maintaining the selected printer 30. The process therefore proceeds to step S60 without step S50 being performed. That is, the selected printer 30 is not set as a candidate printer.

In step S60, the CPU 71 determines whether there are printers 30 that have not been selected in step S20 among the printers 30 included in the information processing system 1. If so, the process returns to step S20, and one of the printers 30 that have not been selected in step S20 is selected.

That is, by repeatedly performing the process from step S20 to step S60 until there are no longer printers 30 that have not been selected, printers 30 located at positions the reference distance or more away from any of the workers 15 are set as candidate printers among the printers 30 included in the information processing system 1.

If it is determined in step S60 that all the printers 30 included in the information processing system 1 have been selected, on the other hand, the process proceeds to step S70.

In step S70, the CPU 71 searches for a printer 30 (also referred to as an “operation printer”) to form an image based on the received image data among the candidate printers.

If there is only one candidate printer, a printer 30 that has been set as the candidate printer is determined as an operation printer. If there are a plurality of candidate printers, on the other hand, the CPU 71 determines one of the candidate printers as an operation printer in accordance with a predetermined search condition.

The “search condition” refers to a condition used to search for a printer 30 beneficial to a user who has requested formation of an image. The “printer 30 beneficial to the user who has requested formation of an image” refers to at least either a printer 30 that is more convenient than the other printers 30 or a printer 30 having properties as close as possible to properties desired by a user (more specifically, a printer 30 having properties desired by the user). When the user needs to pay for the use of the printers 30, a less expensive printer 30 may be regarded as an example of a printer 30 beneficial to a user who has requested formation of an image. It is assumed here, however, that the user can use the printers 30 for free.

When a search condition (hereinafter referred to as “search condition A”) that a printer 30 closest to a user terminal 10 that has transmitted image data be searched for is set, for example, the CPU 71 refers to a correspondence table stored in the nonvolatile memory 74, obtains positional information regarding the user terminal 10, calculates distances between the user terminal 10 and the candidate printers, and determines a printer 30 closest to the user terminal 10 as an operation printer.

The correspondence table is a table on which an identifier and positional information are associated with each of the user terminals 10 included in the information processing system 1. The correspondence table is stored, for example, in the nonvolatile memory 74 in advance.

Since the CPU 71 has stored the identifier of the user terminal 10 that has transmitted the image data in the RAM 73 in step S10, the CPU 71 obtains positional information regarding the user terminal 10 on the basis of the identifier of the user terminal 10.

As mentioned in the description of the distance between the printers 30 and the worker 15, direct distances may be calculated as distances between the user terminal 10 that has transmitted the image data and the candidate printers. Distances along passages, however, may be calculated, instead, in consideration of actual routes that the user will take.

As a result, a printer 30 closest to the user who has requested formation of an image is found.

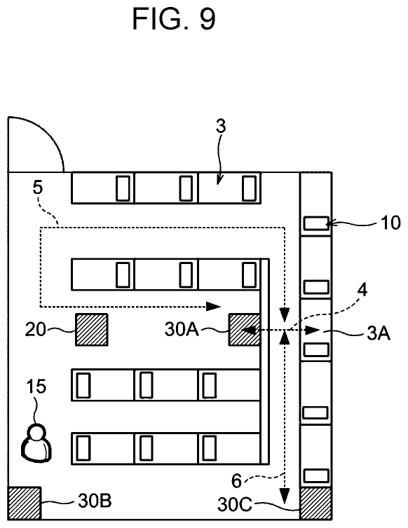

FIG. 9 is a diagram illustrating an example of a plan of the office in which a printer 30 is being maintained. In the example illustrated in FIG. 9, the user has transmitted image data to the printer server 20 from the user terminal 10 provided at a seat 3A with the worker 15 located at a position less than the reference distance away from the printer 30B and the reference distance or more away from the printers 30A and 30C.

The printers 30A and 30C, therefore, are set as candidate printers to form an image based on the image data transmitted by the user. If search condition A that uses direct distances as distances is set in this case, the CPU 71 determines the printer 30A as an operation printer, because a segment 4 indicating a distance between the seat 3A and the printer 30A is shorter than a segment 6 indicating a distance between the seat 3A and the printer 30C.

If search condition A that uses distances along passages as distances is set, on the other hand, the segment 6 indicating a distance between the seat 3A and the printer 30C along a passage (equal to the direct distance between the seat 3A and the printer 30C in the example illustrated in FIG. 9) is shorter than a segment 5 indicating a distance between the seat 3A and the printer 30A along a passage, and the CPU 71 determines the printer 30C as an operation printer.

If a search condition that a printer 30 having properties with which an image of a quality desired by the user can be formed be searched for is set, for example, the CPU 71 refers to a printer property table stored in the nonvolatile memory 74 and determines a printer 30 having properties with which an image of a quality desired by the user can be formed as an operation printer among candidate printers.

The properties of the printers 30 include, for example, supported resolution, supported tone, whether double-sided printing can be performed, and presence or absence of finishers corresponding post-processing such as punching and stapling of the recording medium after an image is formed.

If there is no printer 30 having properties with which an image of a quality desired by the user among the candidate printers, the CPU 71 may determine a printer 30 having properties closest to those desired by the user as an operation printer. If the user desires formation of an image with a resolution level of 1,200×2,400 dots per inch (dpi), and if there is no printer 30 that supports the resolution level of 1,200×2,400 dpi among the candidate printers, for example, a printer 30 that supports a resolution level of 1,200×1,200 dpi, which is a next highest resolution level, is determined as an operation printer. If there are a plurality of printers 30 that support the resolution level of 1,200×1,200 dpi, the CPU 71 may search for an operation printer while combining together a plurality of search conditions. By combining the above-mentioned search condition that a printer 30 closest to a user terminal 10 that has transmitted image data be searched for, for example, a printer 30 that supports the resolution level of 1,200×1,200 dpi and that is provided closest to the user is determined as an operation printer.

The user may set priority levels for search conditions to be used for the printer server 20 using the user terminal 10. If a priority level of a search condition relating to properties of printers 30 is set higher than that of a search condition relating to distances to printers 30, for example, the CPU 71 determines, as an operation printer, a printer 30 that is not closest to the user terminal 10 but has desired properties rather than a printer 30 that is closest to the user terminal 10 but does not have the desired properties.

In step S80, the CPU 71 transmits the image data stored in the RAM 73 in step S10 to the operation printer determined in step S70.

In step S90, the CPU 71 transmits an identifier, such as an IP address or a name, of the operation printer determined in step S70 to the user terminal 10 that has transmitted the image data and ends the process for searching for a printer illustrated in FIG. 8.

As a result, the printer 30 that has received the image data forms the image based on the image data on the recording medium. The user notified, on the user terminal 10, of the printer 30 determined as the operation printer may move to the operation printer and receive the recording medium on which the image based on the image data has been formed.

As described above, the printer server 20 of the information processing system 1 according to the present exemplary embodiment estimates, on the basis of the distances between the printers 30 and the worker 15, a printer 30 that is being maintained. The printer server 20 searches for one of printers 30 that are not being maintained and causes the printer 30 to form an image.

Even in a period in which maintenance of the printers 30 is scheduled to be performed, therefore, the information processing system 1 forms an image based on image data received from the user if there is a printer 30 that is not being maintained.

### First Modification of First Exemplary Embodiment

Although a period in which the printer server 20 obtains the positional information regarding the worker 15 is not particularly limited in the information processing system 1 described above, the period may be limited, instead.

More specifically, since the worker 15 maintains the printers 30 in a scheduled maintenance period for the printers 30, the period in which the positional information regarding the worker 15 is obtained may be limited to the scheduled maintenance period for the printers 30.

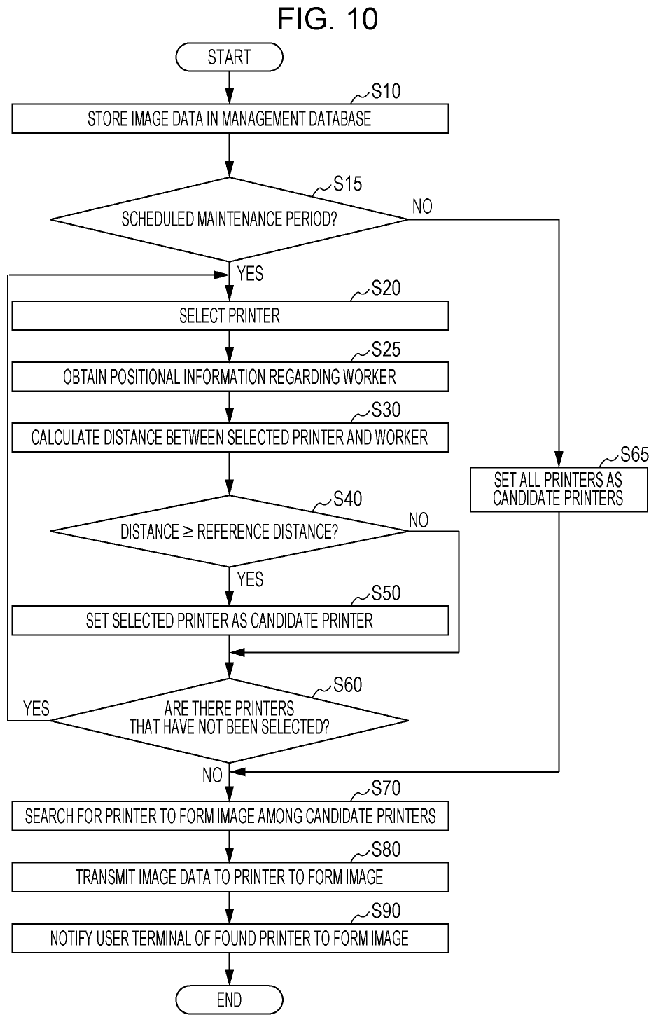

FIG. 10 is a flowchart illustrating an example of a process for searching for a printer performed by the CPU 71 of the printer server 20 when image data has been received from the user terminal 10. In this process, the period in which the positional information regarding the worker 15 is obtained is limited.

The flowchart of FIG. 10 is different from the flowchart of the process for searching for a printer according to the first exemplary embodiment illustrated in FIG. 8 in that steps S15, S25, and S65 are added. The other steps are the same as in the process for searching for a printer according to the first exemplary embodiment. Differences between the process for searching for a printer according to the present modification and the process for searching for a printer according to the first exemplary embodiment will be mainly described hereinafter.

It is assumed that the printer server 20 has obtained the positional information regarding the printers 30 included in the information processing system 1 and has stored the positional information in the nonvolatile memory 74. It is also assumed in the present modification that for convenience of description, a single worker 15 maintains the printers 30.

After the image data received in step S10 is stored in the RAM 73, step S15 is performed.

In step S15, the CPU 71 obtains a present time and determines whether the present time falls within a scheduled maintenance period for the printers 30. The “present time” refers to any time point in a period for which step S15 is performed. Time information is obtained, for example, using a calendar function of the CPU 71. The CPU 71 may obtain the present time from a time server, which is not illustrated, connected to the communication link 2, instead.

For example, the input unit 88A may set a start and an end of the scheduled maintenance period in the printer server 20 in advance, or any user terminal 10 may set the start and the end of the scheduled maintenance period in the printer server 20 through the communication link 2. Alternatively, the CPU 71 may obtain the start and the end of the scheduled maintenance period from an information server, which is not illustrated, connected to the communication link 2 and storing scheduled maintenance periods.

If the obtained present time falls within the scheduled maintenance period, the process proceeds to step S20. In step S20, one of the printers 30 included in the information processing system 1 is selected, and step S25 is performed.

In step S25, the CPU 71 requests the positional information regarding the worker 15 from the positional information management system 50 and obtains the positional information regarding the worker 15. That is, the CPU 71 obtains the positional information regarding the worker 15 only during the scheduled maintenance period for the printers 30.

As described above, the distance between the selected printer 30 and the worker 15 is then calculated using the positional information regarding the worker 15 obtained in step S25 and the positional information regarding the printers 30 stored in the nonvolatile memory 74, and candidate printers are set by comparing the distance with the reference distance.

If it is determined in the determination made in step S15 that the present time does not fall within the scheduled maintenance period for the printers 30, on the other hand, the process proceeds to step S65.

If the present time does not fall within the scheduled maintenance period for the printers 30, it is expected that the worker 15 is not maintaining any of the printers 30 included in the information processing system 1.

In step S65, therefore, the CPU 71 sets all the printers 30 included in the information processing system 1 as candidate printers, and the process proceeds to step S70.

According to the first modification of the present exemplary embodiment, the period in which the positional information regarding the worker 15 is obtained is limited to the scheduled maintenance period for the printers 30. Compared to when the positional information regarding the worker 15 is obtained at predetermined time intervals, for example, a load on the CPU 71 caused by the obtaining of the positional information regarding the worker 15 can be reduced. As the load on the CPU 71 is reduced, power consumption of the printer server 20 might also be reduced.

When a plurality of workers 15 maintain the printers 30, for example, a scheduled maintenance period might be set for each printer 30. In this case, it is difficult to determine in step S15 whether the present time falls within a scheduled maintenance period for a printer 30 before one of the printers 30 included in the information processing system 1 is selected in step S20 illustrated in FIG. 10.

When a plurality of workers 15 maintain the printers 30, therefore, the process proceeds to step S20 after the CPU 71 performs step S10. The CPU 71 may then perform the determination in step S15 after selecting one of the printers 30 in step S20 but before performing step S25. That is, the CPU 71 refers to a scheduled maintenance period for the selected printer 30 stored in the nonvolatile memory 74 in advance, for example, and determines whether the present time falls within the scheduled maintenance period for the selected printer 30. If the present time falls within the scheduled maintenance period for the selected printer 30, the process proceeds to step S25. The CPU 71 may refer to the charge information and obtain positional information regarding a worker 15 who maintains the selected printer 30.

If the present time does not fall within the scheduled maintenance period for the selected printer 30, on the other hand, the process proceeds to step S50, and the selected printer 30 may be set as a candidate printer.

Since the scheduled maintenance period for the printers 30 is just a schedule, an actual maintenance period for the printers 30 might be different from the scheduled maintenance period. For example, the worker 15 might start working before the start of the scheduled maintenance period or might not finish the maintenance of the printers 30 before the end of the scheduled maintenance period.

For this reason, the length of the scheduled maintenance period for the printer 30 may be adjusted, and in step S15, the CPU 71 may determine whether the present time falls within the adjusted scheduled maintenance period for the printers 30. More specifically, a new scheduled maintenance period after the user moves up the start of the scheduled maintenance period by a predetermined period of time or puts off the end of the scheduled maintenance period by a predetermined period of time, for example, may be set in the printer server 20.

It is needless to say that the start of the scheduled maintenance period may be moved up by a predetermined period of time or the end of the scheduled maintenance period may be put off by a predetermined period of time.

An adjustment period applied to the start of the scheduled maintenance period for the adjustment of the scheduled maintenance period is an example of a first period, and an adjustment period applied to the end of the scheduled maintenance period is an example of a second period.

If it is found that the worker 15 has finished the maintenance of the printers 30 before the end of the scheduled maintenance period, the user may change the end of the scheduled maintenance period to an actual end time. As a result, even when the maintenance of the printers 30 has been finished but the worker 15 remains at a position less than the reference distance away from the printers 30, all the printers 30 included in the information processing system 1 are set as candidate printers regardless of the distances between the printers 30 and the worker 15.

### Second Modification of First Exemplary Embodiment

In the information processing system 1 described above, when a candidate printer is set on the basis of a distance between a printer 30 and the worker 15, the distance between the printer 30 and the worker 15 is calculated using latest positional information regarding the worker 15, that is, positional information indicating a latest location of the worker 15, and the positional information regarding the printer 30. If the distance is smaller than the reference distance, the printer 30 is not set as a candidate printer since the printer 30 might be being maintained.

When the worker 15 has finished maintaining a printer 30 but still stays in front of the printer 30, however, it is determined that the printer 30 is being maintained, since the worker 15 is not the reference distance or more away from the printer 30.

A modification of the information processing system 1 that determines whether the worker 15 has finished maintaining a printer 30 even when the worker 15 is not the reference distance or more away from the printer 30 and that, if determining that the worker 15 has finished maintaining the printer 30, sets the printer 30 as a candidate printer will therefore be described hereinafter.

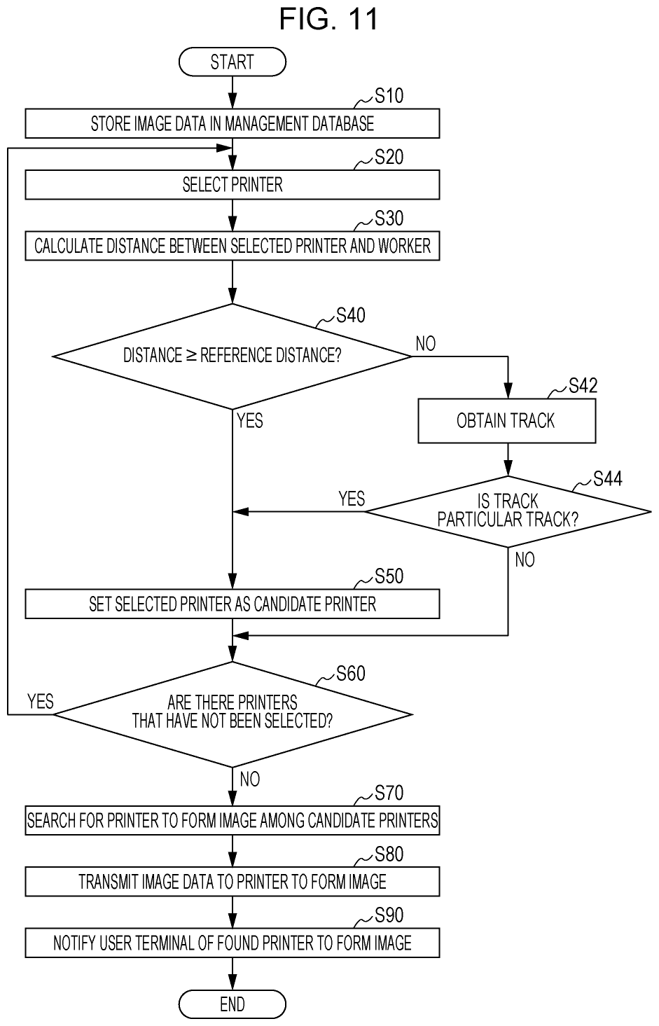

FIG. 11 is a flowchart illustrating an example of a process for searching for a printer according to the present modification performed by the CPU 71 of the printer server 20 when image data has been received from the user terminal 10.

The flowchart of FIG. 11 is different from the flowchart of the process for searching for a printer according to the first exemplary embodiment in that steps S42 and S44 are added. The other steps are the same as in the process for searching for a printer according to the first exemplary embodiment. Differences between the process for searching for a printer according to the present modification and the process for searching for a printer according to the first exemplary embodiment will be mainly described hereinafter.

It is assumed that the printer server 20 has obtained the positional information regarding the printers 30 included in the information processing system 1 at a time when the image data has been received and stored the image data in the nonvolatile memory 74. It is also assumed that the printer server 20 has obtained the positional information regarding the worker 15 at predetermined time intervals and stored the obtained positional information regarding the worker 15 in the nonvolatile memory 74 in time series.

If it is determined in step S40 that the distance between the selected printer 30 and the worker 15 is smaller than the reference distance after the image data is received from the user terminal 10, step S42 is performed.

In step S42, the CPU 71 retrospectively obtains a predetermined number of pieces of positional information regarding the worker 15 stored in the nonvolatile memory 74 in time series from the positional information regarding the worker 15 used in step S30 to calculate the distance between the selected printer 30 and the worker 15.

A movement route and a movement direction of the worker 15 are identified by connecting, by segments, adjacent pieces of the obtained positional information regarding the worker 15 in time series. Adjacent pieces of positional information in time series connected to one another by segments to indicate a movement route and a movement direction in the movement route will be referred to as a “track”.

A track of the worker 15 can be obtained from at least two pieces of positional information. The number of pieces of positional information regarding the worker 15 to be obtained from the nonvolatile memory 74 in time series may therefore be two or more.

In step S44, the CPU 71 determines whether the track of the worker 15 obtained in step S42 is a particular track.

The “particular track” herein refers to a track indicating a movement of the worker 15 with which it is expected that the worker 15 has finished maintaining the printer 30.

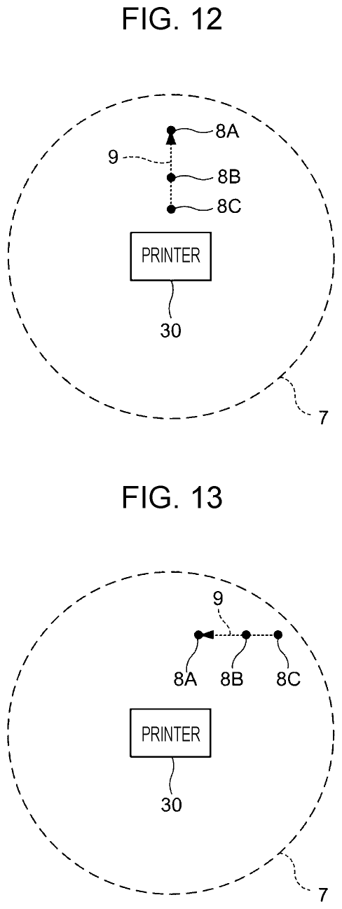

FIG. 12 is a diagram illustrating an example of the particular track. In FIG. 12, dots 8A, 8B, and 8C indicate positions of the worker 15 indicated by positional information regarding the worker 15. An arrow 9 is obtained by connecting the dots 8A, 8B, and 8C to one another by segments and indicates a track of the worker 15. It can be seen that the worker 15 has moved from the dot 8C to the dot 8A via the dot 8B. An area 7 is defined by a circle whose center is a printer 30 and whose radius is the reference distance.

In the example illustrated in FIG. 12, the distance between the printer 30 and the worker 15 is smaller than the reference distance. If the distance between the printer 30 and the worker 15 alone is taken into consideration, it is determined that the printer 30 is being maintained. The arrow 9, however, indicates a track pointing away from the printer 30. Because the worker 15 moves away from the printer 30 after finishing maintaining the printer 30, the track of the worker 15 pointing away from the printer 30 is considered to indicate that the worker 15 has finished maintaining the printer 30. The track indicating that the worker 15 is moving away from the printer 30 is therefore an example of the particular track.

The particular track is not limited to the track indicating that the worker 15 is moving away from the printer 30. As illustrated in FIG. 13, if the printer 30 is not located on the extension of a track of the worker 15 as illustrated in FIG. 13, for example, the worker 15 is considered to be passing by the printer 30. Such a track is also an example of the particular track.

If an obtained track of the worker 15 is a particular track, it is expected that the worker 15 has finished maintaining the selected printer 30 or the selected printer 30 is not to be maintained. The process therefore proceeds to step S50, and the selected printer 30 is set as a candidate printer. That is, even if the selected printer 30 is provided at a position less than the reference distance away from the worker 15, the selected printer 30 is set as a candidate printer.

If the obtained track of the worker 15 is not a particular track, on the other hand, the process proceeds to step S60 without step S50 being performed. That is, the selected printer 30 is not set as a candidate printer.

According to the information processing system 1 according to the second modification, a printer 30 might be set as a candidate printer depending on a track of the worker 15, even if a distance between the printer 30 and the worker 15 is smaller than the reference distance.

Although the present disclosure is applied to formation of an image in the above-described exemplary embodiment, applications of the present disclosure are not limited to formation of an image. The present disclosure may be applied to any scene where a person who carries a mobile terminal 60 (or an object including a mobile terminal 60) searches for an apparatus among apparatuses located a reference distance or more away from the person.

Although an operation apparatus, such as a printer 30, is searched for among operation apparatuses located a reference distance or more away from a person who carries a mobile terminal 60 and the user is notified of the operation apparatus in the above-described exemplary embodiment, an operation apparatus may be searched for among operation apparatuses located less than a reference distance away from a person who carries a mobile terminal 60 and the user may be notified of the operation apparatus, instead. For example, imagine a service offered in a service center in which operators each carry a mobile terminal 60 and a display apparatus (corresponds to the operation apparatus) that displays data files received from user terminals 10 is provided at each counter. In this service, a data file received from a user terminal 10 is received by a server (corresponds to the information processing apparatus) and transmitted to one of the counters. A user is then asked, through the user terminal 10, to go to the counter to which the data file has been transmitted. In this case, the server searches for a counter at which a distance between the display apparatus and the operator is smaller than a reference distance. The user can therefore be guided to an attended counter.

In the above-described exemplary embodiment, an operation printer forms an image without delay after the user requests the formation of the image from the printer server 20 and the printer server 20 searches for the operation printer. The techniques disclosed herein, however, can be applied to a mode in which it takes time until an operation apparatus actually performs a service after the operation apparatus is searched for.

More specifically, the techniques disclosed herein can be applied to a mode in which a user searches for an automated teller machine (ATM) around the user using an information device such as a smartphone, goes to the ATM, and withdraws cash from the ATM.

A server (corresponds to the information processing apparatus) receives, from the information device, a request to search for an ATM (corresponds to the operation apparatus) along with positional information regarding the user and displays, as a recommended ATM on the information device of the user who has given the request, an ATM located within a predetermined distance (e.g., 1 km) from the user and a reference distance or more away from a worker 15 who maintains the ATM. Since the user goes to a location of the recommended ATM and withdraws cash from the ATM, it takes time until cash is withdrawn from the recommended ATM after the recommended ATM is searched for.

In this case, the server determines a distance between an ATM and the worker 15 with which the worker 15 can arrive at the location of the ATM and start maintaining the ATM before the user arrives at the location of the ATM as a reference distance in consideration of time taken for the user to arrive at the location of the ATM. That is, in a mode in which it takes time until an operation apparatus actually performs a service after the operation apparatus is searched for, a server does not identify an operation apparatus to be maintained by comparing a distance between the operation apparatus and a worker 15 with a fixed reference distance. The server may identify an operation apparatus to be maintained by comparing the distance between the operation apparatus and the worker 15 with a reference distance that is set for each operation apparatus and that varies depending on a distance between a user and the operation apparatus.

Although the present disclosure has been described using an exemplary embodiment, the present disclosure is not limited to the exemplary embodiment. The exemplary embodiment may be modified or improved in various ways without deviating from the scope of the present disclosure, and the technical scope of the present disclosure also includes modes obtained as a result of such modification or improvement. For example, the order of steps may be changed insofar as the scope of the present disclosure is not deviated from.

Although a mode in which the processes for searching for a printer are achieved by software has been described as an example in the above-described exemplary embodiment, processes equivalent to those described in the flowcharts of FIGS. 8, 10, and 11 may be incorporated into an application-specific integrated circuit (ASIC), and hardware may achieve the processes. In this case, the processes can be performed at higher speed than when the processes are achieved by software.

Although a mode in which the information processing program is stored in a ROM has been described in the above-described exemplary embodiment, the information processing program need not be stored in a ROM. The information processing program in the present disclosure may be stored in a computer-readable storage medium and provided. For example, the information processing program in the present disclosure may be stored in an optical disc such as a compact disc read-only memory (CD-ROM) or a digital versatile disc read-only memory (DVD-ROM) and provided. Alternatively, the information processing program in the present disclosure may be stored in a semiconductor memory and provided.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an obtaining unit that obtains positional information regarding a worker who maintains an operation apparatus that performs a process requested by a user; and
a search unit that searches for, among a plurality of operation apparatuses, an operation apparatus provided at a position a predetermined distance or more away from a position indicated by the positional information obtained by the obtaining unit as an operation apparatus to perform the process requested by the user.

2. The information processing apparatus according to claim 1,
wherein, if there are a plurality of operation apparatuses provided at positions the predetermined distance or more away from the position indicated by the positional information obtained by the obtaining unit, the search unit searches for an operation apparatus among the plurality of operation apparatuses in accordance with a predetermined search condition.

3. The information processing apparatus according to claim 2,
wherein a condition that, among the plurality of operation apparatuses, an operation apparatus closest to a user terminal used by the user to request the process be searched for is set as the predetermined search condition.

4. The information processing apparatus according to claim 3,
wherein distances between the user terminal and the plurality of operation apparatuses are indicated by distances along passages through which the user moves from the user terminal to the operation apparatuses.

5. The information processing apparatus according to claim 2,
wherein a condition that, among the plurality of operation apparatuses, an operation apparatus having a property required to achieve the process requested by the user be searched for is set as the predetermined search condition.

6. The information processing apparatus according to claim 3,
wherein a condition that, among the plurality of operation apparatuses, an operation apparatus having a property required to achieve the process requested by the user be searched for is set as the predetermined search condition.

7. The information processing apparatus according to claim 4,
wherein a condition that, among the plurality of operation apparatuses, an operation apparatus having a property required to achieve the process requested by the user be searched for is set as the predetermined search condition.

8. The information processing apparatus according to claim 1,
wherein the obtaining unit obtains the positional information within a limited period.

9. The information processing apparatus according to claim 2,
wherein the obtaining unit obtains the positional information within a limited period.

10. The information processing apparatus according to claim 3,
wherein the obtaining unit obtains the positional information within a limited period.

11. The information processing apparatus according to claim 4,
wherein the obtaining unit obtains the positional information within a limited period.

12. The information processing apparatus according to claim 5,
wherein the obtaining unit obtains the positional information within a limited period.

13. The information processing apparatus according to claim 8,
wherein the obtaining unit obtains the positional information in a period that starts at a time point a first period before a scheduled start time of maintenance for each of the operation apparatuses and that ends at a time point a second period after a scheduled end time of maintenance.

14. The information processing apparatus according to claim 1,
wherein the obtaining unit obtains the positional information a plurality of times, and
wherein, if a track of the positional information obtained by the obtaining unit in time series is a particular track, the search unit includes even an operation apparatus provided at a position less than the predetermined distance away from positions indicated by the positional information obtained by the obtaining unit in search targets as one of candidate operation apparatuses to perform the process requested by the user.

15. The information processing apparatus according to claim 14,
wherein the particular track is a track pointing away from the operation apparatus provided at the position less than the predetermined distance away from the position indicated by the positional information.

16. The information processing apparatus according to claim 1,
wherein, if the obtaining unit has obtained positional information regarding a plurality of workers, the search unit searches for an operation apparatus provided at a position the predetermined distance or more away from any of the plurality of workers located at positions indicated by the positional information obtained by the obtaining unit.

17. The information processing apparatus according to claim 1,
wherein, if maintenance of each of the operation apparatuses is finished before a scheduled maintenance period for the operation apparatus ends, the search unit searches for one of the plurality of operation apparatuses regardless of the predetermined distance.

18. A non-transitory computer readable medium storing a program causing a computer to execute a process for processing information, the process comprising:
obtaining positional information regarding a worker who maintains an operation apparatus that performs a process requested by a user; and
searching for, among a plurality of operation apparatuses, an operation apparatus provided at a position a predetermined distance or more away from a position indicated by the positional information obtained in the obtaining as an operation apparatus to perform the process requested by the user.

19. An information processing system comprising:
an information processing apparatus including an obtaining unit that obtains positional information regarding a worker who maintains an operation apparatus that performs a process requested by a user and a search unit that searches for, among a plurality of operation apparatuses, an operation apparatus provided at a position a predetermined distance or more away from a position indicated by the positional information obtained by the obtaining unit as an operation apparatus to perform the process requested by the user; and
an operation apparatus including a reception unit that receives the process requested by the user from the information processing apparatus and a control unit that performs control such that the process received by the reception unit is performed.

20. The information processing system according to claim 19,
wherein the operation apparatus includes a transmission unit that transmits positional information regarding a position at which the operation apparatus is provided, and
wherein the obtaining unit of the information processing apparatus obtains the positional information regarding the operation apparatus transmitted from the transmission unit of the operation apparatus.
